(19) United States
(12) Patent Application Publication
(10) Pub. No.: US 2011/0262332 A1
(43) Pub. Date: Oct. 27, 2011

(54) Apparatus and Method for the Treatment of Gas

(76) Inventors: Istvan Szabo, Boda Kyrkby (SE); Berton Arespång, Hedemora (SE)

(21) Appl. No.: 13/140,456

(22) PCT Filed: Dec. 14, 2009
(86) PCT No.: PCT/SE2009/000513

§ 371 Date: Jun. 17, 2011

Related U.S. Application Data
(60) Provisional application No. 61/159,501, filed on Mar. 12, 2009.

(30) Foreign Application Priority Data
Dec. 18, 2008 (SE) 0802608-0
Dec. 20, 2008 (SE) 0802648-6

(51) Int. Cl. B01D 53/56

(52) U.S. Cl. 423/235; 422/120; 422/122

(57) ABSTRACT

An apparatus for the decomposition of a gaseous agent in exhaled air from patients, comprising a gas flow line along which there is a) an inlet arrangement, b) a decomposition unit with a chamber for decomposition of the agent, and c) an outlet arrangement. The characteristic feature is the presence of a gas regulating arrangement comprising a) a gradually adjustable function, e.g. a blower, for adjusting the flow through the chamber, and b) an optional by-pass valve function permitting adjustment of the gas pressure upstream of the adjustable function. An apparatus of the same kind as in the first sentence of the previous paragraph in which the chamber is combined with a regenerative heat exchanger preferably equipped with a puff filter. Methods are also claimed.

### FIELD OF INVENTION

The present invention relates to an apparatus (1^{st} apparatus aspect) for processing gas deriving from exhaled air of a plurality (=one, two or more) of patients to which have been administered gas containing an added gaseous agent. The gaseous agent typically has an anaesthetic and/or analgesic effect. The processing results in a waste gas which has an acceptable level of the agent in order to be delivered to ambient air. In other aspects, the invention relates to a) an apparatus for processing gaseous agents in general, b) decomposition units for catalytic degradation of gaseous agents primarily is physiologically active in same manner as indicated above and in the subsequent paragraph, and c) methods in which the apparatuses and/or the decomposition units can be used for decomposition of a gaseous agent in admixture with other gases. The gaseous agent and the gas are typically as described elsewhere in this specification.

The gaseous agent primarily is physiologically active when administered in inhaled air and typically has anaesthetic and/or analgesic effects. It is primarily nitrous oxide (N₂O), which is known to have both of these effects, but may also include or be one or more other gaseous physiologically active agents, for instance having a pronounced anaesthetic effect (anaesthetic agents). Typically agents of the latter kind are found amongst gaseous organic compounds (VOCs), such as amongst gaseous halo-containing hydrocarbons and halo-containing ethers. When an anaesthetic agent, in particular in the form of a VOC, is included, the inhaled air/gas is called an anaesthetic gas. The agent may also be selected amongst other gaseous agents, e.g. other VOCs, having a desired physiological effect on patients. Normal air constituents, such as oxygen, nitrogen, carbon dioxide etc are not included amongst physiologically active gaseous agents as described in this paragraph or elsewhere in this specification.

### DRAWINGS

FIG. 1 illustrates an apparatus of the invention with a range of optional features.

FIG. 2 illustrates a preferred apparatus comprising a decomposition unit in which the decomposition chamber and heating arrangements (regenerative heat exchanger and heating elements) are integrated in the same block.

FIG. 3 illustrates a preferred apparatus comprising two heat exchangers.

FIGS. 4 and 5 illustrate decomposition units comprising a decomposition chamber which is closely integrated with a regenerative heat exchanger. Undesired puffs containing the gaseous agent in the effluent gas from the apparatus are taking care of in a puff filter downstream of the decomposition chamber.

Reference numerals in the figures comprise three digits. The first digit refers to the number of the figure and the second and third digits to the specific item. Corresponding items in different figures have as a rule the same second and third digits. Dashed lines represent data/signal communication between various functions along the flow line and those parts of the control unit that are located to the control block. Regenerative heat exchangers were erroneously called recuperative heat exchangers in the SE priority applications.

### BACKGROUND TECHNOLOGY

Nitrous oxide is considered to be an air pollutant which is at least 300 times more effective than carbon dioxide as a “green house gas”. It is also considered hazardous for people exposed to it during work (e.g. doctors, dentists, nurses etc). Occupational health limits have been set to 25 ppm. Within health care units nitrous oxide is used within surgery, dental care, maternity care during delivery etc. The typical patient is allowed to inhale a gas mixture in which the main components are nitrous oxide (about 20-70% v/v) and oxygen (=inhalation air). When an enhanced anaesthetic effect is desired, the mixture also contains a gaseous anaesthetic agent (as a rule <2% v/v). The composition of air exhaled by a patient receiving these kinds of gases is essentially the same as the inhaled air except that there typically is an increase in moisture (water) and carbon dioxide. Exhaled air from a patient inhaling a gas containing nitrous oxide is typically diluted with normal air before being further treated, e.g. in a nitrous oxide decomposition apparatus and/or passed into ambient atmosphere.

Nitrous oxide is also present in gases produced within certain process industries and as exhaust gases from vehicles based on fossil fuels (cars, buses and the like). However, the concentrations and amounts of nitrous oxide in such gases are as a rule significantly lower than in the gases used within the health care sector. Solutions for minimizing the level of nitrous oxide in waste gases from process industries, cars and the like are as a rule not simply transferable to the health care sector.

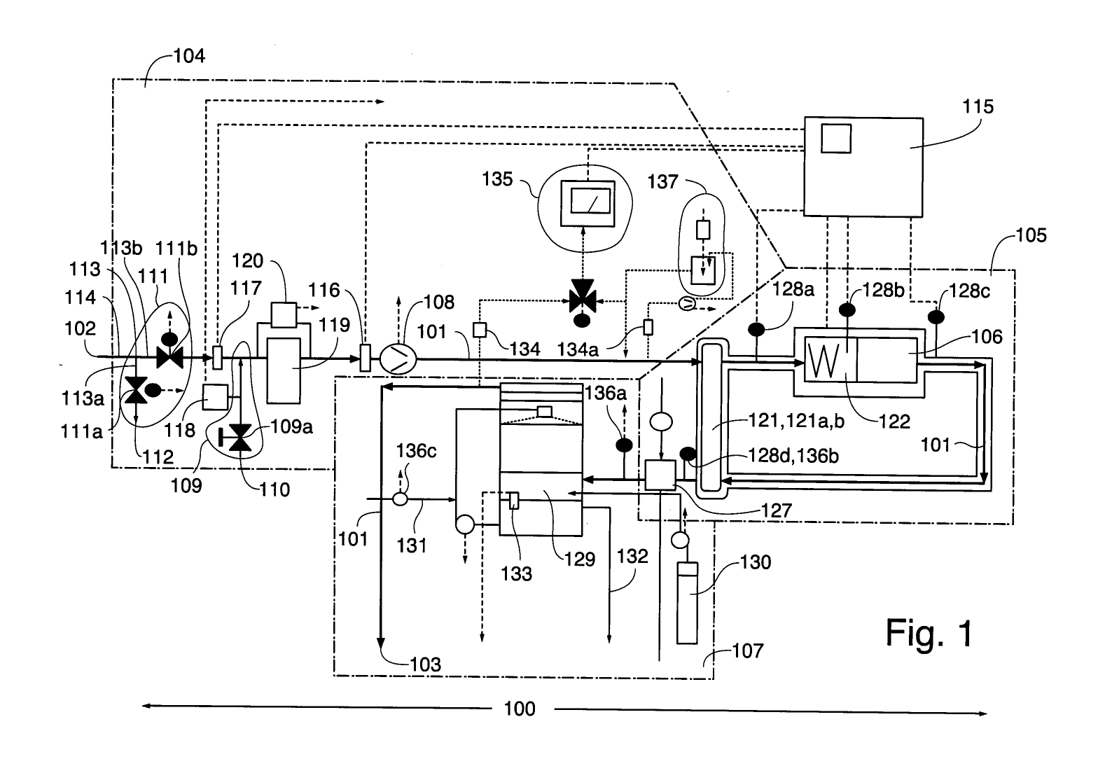

Apparatuses for removal of an agent of the kind defined above from gases deriving from health care units have been described before. Based on the FIGS. 1-3, previously known apparatuses have as a rule comprised
a) an inlet arrangement (104,204,304) which in the upstream direction is capable of being placed in simultaneous gas flow communication with a plurality of patients (one, two, three or more patients,
b) a flow-through decomposition unit (105,205,305) in which there is a flow-through decomposition chamber (106) which is capable of decomposing the gaseous agent discussed above, typically by catalysis,
c) an outlet arrangement (107,207,307) in gas flow communication with ambient air, and
d) a gas flow line (101,201,301) passing through a), b) and c) in the order given and having an inlet end (102,202,302) and an outlet end (103,203,303).

In other words the decomposition unit (105,205,305) is in the upstream direction in gas flow communication with the inlet arrangement (104,204,304) and in the downstream direction with the outlet arrangement (107,207,307). The decomposition unit has typically also comprised a heating arrangement for providing a sufficient decomposition temperature in the decomposition chamber during the period of time for decomposition, e.g. during contact between a catalyst and the gas flowing through the chamber. In apparatuses for treating anaesthetic gases containing nitrous oxide and an anaesthetic agent, it has been considered important to include a separate unit for removal of the anaesthetic agent by adsorption at a position upstream of a nitrous oxide decomposing unit or chamber.

Some Earlier Publications are:

Anaesthetic gases: DE 42087521 (Carl Heyer GmbH), DE 4308940 (Carl Heyer GmbH), U.S. Pat. No. 7,235,222 (Showa Denko KK), U.S. Pat. No. 4,259,303 (Kuraray Co., Ltd), WO 2006059606 (Showa Denko KK), WO 2002026355 (Showa Denko KK), JP publ No. 55-031463 (Kuraray Co Ltd), JP publ No. 56-011067 (Kuraray Co Ltd).

Gases containing nitrous oxide without an anaesthetic agent 1 (maternity careafter delivery and the like): U.S. Pat. No. 7,235,222 (Showa Denko KK), WO 2006059606 (Showa Denko KK), WO 2002026355 (Showa Denko KK),
Undefined health care use of gases containing nitrous oxide: JP publ No. 2006230795 (Asahi Kasei Chemicals Corp).

Commercially available nitrous oxide treating apparatuses are expensive and relatively complex and bulky. In many instances they are inconvenient and/or non-flexible to use and install. There is a desire for improved nitrous oxide decomposition apparatuses which provide/are:
a) a high degree of automation with respect to adjustment of process parameters, such as i) temperature in the reactor and in the waste gas, and/or ii) gas pressure and/or gas flow in the reactor, etc,
b) reliability with respect to efficiency in decomposing nitrous oxide to harmless products including accomplishing zero or only trace levels of nitrogen oxides in the effluent gas (primarily nitrous oxide and NOₓ where x is an integer 1 or 2),
c) cheap and easy to buy, install and use,
d) compact,
e) easily connectable and adaptable to different numbers of patients, preferably by self-sensing when there is a change in the number of patients connected to the apparatus and/or automatic adaptation of process parameters, such as gas pressure and/or gas flow at positions upstream of the decomposition unit i.e. in the inlet arrangement,
f) service-friendly, e.g. easy to replace filters, catalyst material, etc,
g) increased cost-efficiency with respect to utilization of the catalyst, input of energy etc.

Patents and patent applications cited herein, in particular US variants, are hereby incorporated in their entirety by reference.

A novelty search carried out by the SE patent office in the SE priority application 0802648-6 has cited a) WO 02/26355 (Showa Denko) and GB 2059934 (Kuraray) as describing apparatuses for degrading of anaesthetic gases, and b) WO 2006/124578 (Anaesthetic Gas Reclamation LLC) as describing apparatus in the same field that are connected to a plurality of patients. These three publications are scarce about controlling process parameters for the degradation of the above-mentioned gaseous agents.

### OBJECTS OF THE INVENTION

The objects of the present invention are to provide solutions to problems linked to the removal of the gaseous agents discussed above from air exhaled by patients inhaling air containing one or more of these agents. Particular objects encompass meeting at least partially one or more of the desires (a)-(g) discussed in the preceding paragraphs.

Other objects are to provide solutions to similar problems with respect to undesired gaseous components in gases in general.

### The Invention

It has now been realized that it is favourable to design apparatuses of the type defined in the introductory part with a gas regulating arrangement and/or a control unit that are capable of supporting that flow through the decomposition chamber can a) automatically be maintained while the catalyst is heated irrespective of a patient being connected or not, and b) automatically be adapted to changes in number of patients connected. This kind of design can favourably be combined with other features as described below.

It has also been realized that the construction and design of compact apparatus and decomposition units are facilitated if the decomposition unit is allowed to comprise a regenerative heat exchanger in close association with the decomposition chamber.

It has also been realized that by using a decomposition unit comprising a decomposition chamber in combination with a regenerative heat exchanger there is a risk for puffs of the undesired gaseous agent in the effluent gas from the unit. Solutions to this problem have also been found.

It has also been realized that effective nitrous oxide decomposing catalysts can be found amongst catalysts having a broad specificity for decomposing volatile organic compounds (VOCs) opening up a potential possibility of catalytic decomposition of nitrous oxide and VOCs by the same catalyst.

### Main Aspects of the Invention

Accordingly the invention relates to apparatuses and decomposition units of the kinds defined under the heading “Background Technology” above, and to a method and use of the apparatus and the units for removing the undesired gaseous agents discussed above from gas containing such an agent, primarily exhaled air containing the agent.

A characterizing feature of a main apparatus aspect (1^{st}) is that the apparatus (100,200,300) comprises a gas regulating arrangement, e.g. as defined below, which is capable of supporting, independent of number of patients connected to the apparatus, flow of gas through the decomposition chamber (106,206,306). In this context the number of patients means none, one, two or more. This flow is typically increased with increasing number of patients connected to the apparatus, decreased with decreasing number of patient, and at minimum when no patient is connected. The minimum flow is called threshold flow (threshold value). Since heating typically is required for the decomposition process to occur, this feature enables heating to be maintained at he process/working temperature when the number of connected patients is changed. The feature also enables heating when no patient is connected, typically to maintain the temperature in the decomposition chamber (106,206,306) above room temperature but below the process temperature, such as to ≧50° C. or ≧100° C. or ≧200° C. or ≧300° C. and/or with a reduction in temperature with ≧10° C. or ≧50° C. or ≧100° C. or ≧200° C. or ≧300° C. below the process temperature, or to maintain the process temperature. In total this means shortened and simplified starting up procedures after periods when no patients are available.

The term “flow” above and elsewhere in the specification refers to volumetric flow (volume of gas/unit of time) if not otherwise indicated by the context. The term does not include zero flow which is a non-flow or static condition.

In preferred variants the gas regulating arrangement is capable of maintaining gas subpressure within a preset interval around a desired value (target subpressure value) in a part of the flow line (101,201,301) of the inlet arrangement.

Subpressure in the preceding paragraph and elsewhere in the specification is a negative pressure relative to the pressure of ambient atmosphere, such as ambient air or some other external gas source in gas communication with the part of the flow line associated with the inlet arrangement (e.g. via a by-pass valve).

In preferred variants of this main apparatus aspect (1^{st}), there is also a control unit as defined below for securing that there is always a flow of gas as discussed below through the decomposition chamber (106,206,306) irrespective of number of patients connected to the apparatus (100,200,300) and/or for controlling and/or adjusting one or more other process parameters and/or functions which are present in the apparatus (100).

A characterizing feature of another main apparatus aspect (2^{nd}) is that the decomposition unit (205) of the apparatus (200) comprises a regenerative heat exchanger (221a,b) as described below.

A characterizing feature of still another main apparatus aspect (3^{rd}) is that the decomposition chamber (105,205,305) of the apparatus (100,200,300) comprises a catalyst capable of decomposing the physiologically active agent present in the exhaled air without formation of undesired products in unacceptable levels in gases leaving the decomposition chamber (106,206,306) or the outlet end (103,203,303) of the flow line (101,201,201) of the apparatus. In preferred variants this means catalysts capable of decomposing both nitrous oxides and VOCs.

The decomposition unit aspects have as their most generic characterizing feature that they comprise either one or both of the features given for the 2^{nd} and 3^{rd} apparatus aspect. See the two preceding paragraphs and below.

Subaspects of these main apparatus and decomposition unit aspects have as characterizing features the various embodiments described below.

### Gas Regulating Arrangement

The gas regulating arrangement comprises i) a function (108,208,308) for creating and changing (increasing and decreasing) the flow velocity of gas entering the decomposition chamber (106,206,306), and/or ii) a valve function (109,209,309) associated with the flow line in the inlet arrangement for inlet of gas from ambient atmosphere to the flow line and/or for outlet of excess gas from the flow line and/or for regulating gas subpressure (increasing and decreasing) in flow line of the inlet arrangement (104). Valve function (ii) (109,209,309) is upstream of function (i) when both of them are present simultaneously. Valve function (ii) is physically separate from the inlet end (102,202,302) of the flow line as illustrated in the drawings. Valve function (109,209,309) is typically called a by-pass valve).

The term “ambient atmosphere” in gas flow communication with the flow line for inlet or outlet of gas from/to the flow line and/or for regulating gas subpressure inside the flow line includes in particular ambient air but also various kinds of containers/sources containing an inert external gas and having this function.

The function (108,208,308) and valve function (109,209,309) are preferably gradually adjustable. For function (108,208,308) this means that it shall allow for a gradual change in flow. For valve function (109,209,309) this means that it comprises a valve (109a,209,a,309a) providing an adjustable opening to ambient atmosphere (110,210,310). The opening can be preset to desired values each of which will support a range of different target/desired values for inlet flow from ambient atmosphere and/or subpressure values in the flow line at the valve (109a,209a,309a).

The function (108,208,208) is typically a blower placed in the flow line (101,201,301). The position of the blower is typically outside of the decomposition chamber (106,206,306), i.e. upstream or downstream of the decomposition chamber (106,206,306) or the decomposition unit (105,205,305). Preferred positions for the function (108,208,208) are within the inlet arrangement, and/or downstream of one or more valve functions (109,209,309) for inlet of ambient atmosphere (110 if valve function (109,209,309) is present.

The pressure differential that creates the flow may alternatively be created at the inlet or at the outlet end (102,202,302 and 103,203,303, respectively) of the flow line (101,201,301) and/or even upstream or downstream, respectively, of these ends. Thus function (108,208,308) may also be placed outside the flow line (101,201,301) or at either one or both of its ends (102,202,302 and 103,203,303, respectively). Means other than a blower may potentially also be used as function (108,208,308).

Flow creating functions (108,208,308) may also be defined by a combination of two or more separate functions, e.g. one function for creating a basic more or less constant flow and a second function for creating the changes. Thus a combined function may comprise a stop-run blower combined with a blower for creating gradual variations in flow. Another combination is a stop-flow valve for constant or none flow combined with a blower creating gradual changes in flow when the valve is opened.

The flow line may also comprise other kinds of valves and valve functions not directly involved in securing a proper and stabile flow through the decomposition chamber. Thus there may be a three-way valve function (111,211,311) for disconnecting in a stop-flow wise manner incoming flow, for instance to guide influx of gas to ambient atmosphere (112,212,312) or to a gas storage tank and/or to close the flow line in the inlet arrangement (104,204,304). This valve function may contain a branching (113,213,313) with a separate stop-flow valve (111a,b,212a,b,312a,b) in one or both of the branches (113a,b,213a,b,313a,b) and/or in the in-coming part (114,214,314) of the flow line upstream of the branching (not shown). If this kind of valve function leads gas to a storage tank containing e.g. a body adsorbing the gaseous physiologically active agent, the agent stored by adsorption might subsequently be released in gaseous form and allowed to re-enter the flow line (101,201,301) and treated in the decomposition chamber (106,206,306).

The apparatus may also exhibit other flow and pressure regulating functions that are not primarily involved in securing flow to be above a threshold value and/or within a predetermined flow interval. These other functions will be discussed in more detail under the headings inlet arrangement, decomposition unit and outlet arrangement.

### Control Unit

The control unit comprises various kinds of sensors located along the flow line for measuring different process parameters, e.g. flow through the inlet arrangement, through the decomposition chamber etc, and/or subpressure in the flow line of the inlet arrangement etc. In preferred variants the control unit also comprises soft-ware for comparing/checking and adjusting process parameters, and one or more computers loaded with such soft-ware. The latter parts of the control unit will be called the control block (115,215,315) and may comprise different parts having the same or separate physical locations.

The control unit thus is capable of a) measuring flow of gas entering the decomposition chamber, and, if so desired, also the subpressure in the inlet arrangement, optionally combined with b) comparing/checking obtained values with desired preset values, respectively, and/or c) adjusting flow and/or subpressure to be above a threshold value for flow and/or within a preset subpressure interval around a preset desired subpressure value. A desired level for flow is typically above a corresponding threshold value. In further preferred variants the control unit manages with automatic measurement, comparison and/or adjustment of flow and/or subpressure in the inlet arrangement. An automatic alarm function may preferably be part of the control unit in the case of failure to comply with one or more preset limits, levels and/or intervals for flow and/or gas pressure.

A flow sensor (flow meter, 116,216,316) for measuring flow may be placed along the flow line (101,201,301) upstream or downstream of the decomposition chamber (106,206,306), with preference for upstream), and/or upstream or downstream of the flow regulating function (108,208,308). The flow sensor (116,216,316) and the flow regulating function (108,208,308) are associated with each other such that the flow immediately downstream of the flow regulating function (108,208,308) and through the decomposition chamber is related to or is a function of the flow measured by flow sensor (116,216,316). In the case the flow creating function (108,208,308) is combined with a valve function (109,209,309) for inlet of external gas, the flow sensor (116,216,316) is typically placed downstream of such a valve.

The control unit may also comprise one or more additional flow sensors. An extra flow sensor (117,217,317) may thus be placed downstream of the above-mentioned valve function (109,209,309) for inlet of external gas for measuring exclusively the inlet of patient-derived gas containing the agent, e.g. nitrous oxide, without including influx of the external gas through valve function (109,209,309).

Differences between flow measured by the two flow sensors (116,216,316) and (117,217,317) will reflect the inlet flow from ambient atmosphere through valve function (109,209,309) and may be used for controlling the flow through the decomposition chamber (106,206,306) in response to changes in number of patients connected to the apparatus. See the experimental part. Alternatively the difference between the two flow sensors (116,216,316) and (117,217,317) may be replaced by measurement using a flow sensor placed in association with the inlet valve (109a,209a,309a) (not shown).

A pressure sensor (118,218,318) for measuring pressure used for regulating flow through the decomposition chamber (106,206,306) is typically located upstream of flow regulating function (108,208,308) with preference in association with the inlet valve (109a,209a,309a). The suppressure measured at this valve function can thus be used to control the flow created by function ((108,208,308) via the control unit in the same manner as for flow in the preceding paragraph.

Illustrative threshold values for flow are suitably ≧0.5 m³/h or ≧1 m³/h ≧5 m³/h ≧10 m³/h. This means that the desired flow for a particular number of patients connected to the apparatus typically is above one or more of these threshold values with preference for desired levels being increasing with, such as proportional to, the actual number of patients connected to the apparatus, and typically with the lowest flow for zero patients (=threshold value). The upper limit for the flow is typically ≦2000 m³/h, such as ≦1000 m³/h or ≦500 m³/h or ≦250 m³/h or ≦100 m³/h or ≦50 m³/h and depends on how many patients the apparatus is designed for including also volume of decomposition chamber, selection of catalyst, capacity for heating incoming gases etc.

The pressure in the flow line of the inlet arrangement (104,204,304) at the valve (109a,209a,309a) is typically below the pressure of ambient atmosphere, that are in gas flow communication with this part of the flow line, for instance via valve function (109,209,309). In preferred variants this typically means a gas pressure ≧0.5 bar and <1 bar. Thus preferred subpressure values at this position to be used as preset desired/target values are found in the interval of −1 Pascal to −500 Pascal, such as −1 Pascal to −100 Pascal or −1 Pascal to −50 Pascal. See further the experimental part.

The apparatus may also exhibit other measuring functions not primarily related to securing flow and/or regulating flow and pressure as discussed above and in the experimental part. These other functions will be discussed in more detail below.

The control unit of the apparatus of the invention may in addition to the functions for measuring, checking and adjusting flow and gas pressure discussed above comprise functions enabling at least one of (a)-(g):

a) functions for
i) measuring and/or checking the temperature at one or more positions in the flow line in the decomposition unit (105,205,305), with preference for positions in the decomposition chamber (106,205,305) or immediately upstream or downstream thereof, by the use of a temperature sensor (128a,b,c . . . , 228a,b,c . . . , 328a,b,c . . . ) at each of these positions, and/or
ii) alarming if the temperature sensed at any of the positions is outside a predetermined process temperature interval (the working interval), and/or
iii) adjusting the temperature within the decomposition chamber (106,206,306) to be within the predetermined temperature interval by the use of a heating arrangement placed in the decomposition unit;
   b) functions for
i) measuring and/or checking the reduction in the level of nitrous oxide between a position upstream and a position downstream of the decomposition chamber (106,206,306) by the use of a nitrous oxide sensor arrangement (134+134b+135+137, 234+234a+235+237, 334+334a+335+337) connected at these two positions, and/or
ii) alarming if the reduction is below a predetermined level, and/or
iii) adjusting one or more process parameters to increase said reduction in the level of nitrous oxide,
said checking, alarming and/or adjusting with preference being carried out automatically by the control unit;
   c) functions for
i) measuring and/or checking the level of nitrogen oxides other than nitrous oxide ((e.g. NOₓ where x primarily is an integer 1 or 2) at a position downstream of the decomposition chamber (106,206,306) (sensor not shown in drawings), and/or
ii) alarming if the level is above a preset level and/or
iii) adjusting one or more process parameters to decrease the level of said nitrogen oxides other than nitrous oxide;
   d) functions for
i) measuring and/or checking the level of nitrous oxide by a nitrous oxide sensor arrangement (134+135+137,234+235+237,334+335+337) connected at a position downstream of the decomposition chamber (106,206,206), and/or
ii) alarming if the level is above a preset level, and/or
iii) preferably adjusting one or more process parameters to decrease the level of nitrous oxide;
   e) functions for
i) checking the status of the catalyst based on values of a combination of at least one process parameter to accomplish
   a) a predetermined reduction in nitrous oxide, and/or
   b) a level of one or more by-products from the decomposition taking place in the decomposition chamber, e.g. nitrogen oxides other than nitrous oxide, below preset threshold values for said by-product(s), respectively,
in gas exiting the decomposition chamber or in waste gas from the apparatus, for nitrous oxide preferably measured relative to the level of nitrous oxide in gas entering the decomposition chamber, and/or
ii) alarming if the reduction and/or level(s) of said at least one process parameters indicate poor functioning of the catalyst;
   f) functions for
i) measuring and/or checking the temperature in gas exiting the outlet end (103,203,303) of the flow line (101,201,301) of the apparatus by the use of a temperature sensor placed in association with the outlet end (103,203,303), and/or
ii) alarming if the temperature is above a preset temperature, and/or
iii) lowering the temperature in gas exiting the apparatus by increasing the cooling upstream of the temperature sensor, e.g. in a cooling arrangement, and/or lowering the heating in the decomposition unit, and/or changing one or more other process parameters lowering the temperature of the gas exiting through the outlet of the flow line;
   g) functions for
i) measuring and/or checking the pressure drop and/or flow resistance across a particle filter (119,219,319) placed in the flow line at a position upstream of the decomposition chamber, preferably in the inlet arrangement, and/or
ii) alarming if the pressure drop/flow resistance exceeds a predetermined value.

With respect to checking the status of the catalyst the most relevant process parameters are believed to be the level of nitrous oxide and/or the level of nitrogen oxides other than nitrous oxide in gases exiting the decomposition chamber (106,206,306), for instance as measured in the outlet arrangement (107,207,307). For nitrous oxide the reduction level is believed to be most relevant, i.e. the level of nitrous oxide downstream of the decomposition chamber relative to the level of nitrous oxide in gas that is to enter the decomposition chamber (106,206,306). See also (b), (c) and (d) above and under below the heading “Decomposition unit”.

Relative reduction in the preceding paragraph includes measures such as percentage reduction, reduction in absolute concentration etc.

Items (c)-(e) refers specifically to nitrous oxide as the agent to be decomposed. They are also applicable to other agents with the proviso that the levels, by-products/products and process parameters then have to be adapted to those valid for the particular agent concerned.

The checking, alarming and/or adjusting in each of one, more or all of (a)-(g) are with preference carried out automatically by the control unit.

### Inlet Arrangement

The inlet arrangement (104,204,304) primarily comprises the upstream part of the flow-line (101,201,301) and various flow and pressure regulating functions as described above for the gas regulating arrangement together with various sensors and metering/measuring functionalities as described for the control unit. In addition there may be other functionalities.

In a preferred variant there may thus be a particle filter (119,219,319), typically located upstream of the decomposition chamber (106,206,306), such as upstream of the decomposition unit (105,205,305). In the case a flow regulating function (108,208,308), such as a blower, is present in the inlet arrangement (104,204,304), the preferred position of the particle filter is upstream flow regulating function (108,208,308). The particle filter (119,219,319) is typically downstream of a valve (111b,211b,311b) for closing the flow line (101,201,301) at the inlet end (102,202,302) and downstream of a valve function (109,209,309) for inlet of external gas for adjusting gas pressure in a part of the flow line (101,201,301) of the inlet arrangement, (103,203,303) if such valves are present.

A sensor (120,220,320) for measuring pressure drop and/or flow resistance across the particle filter (119,219,319) and/or changes in either one or both of these two parameters is preferably associated with the particle filter.

Upstream of a particle filter (119,219,319) there preferably is a valve function (111,211,311) for disconnecting flow through the filter thereby facilitating its replacement when being clogged. This valve is possibly combined with a valve function at the downstream end of the filter (not shown). The valve at the upstream end of the filter may coincide with (be the same as) the above-mentioned valve (111b,211b,311b) for closing the inlet end of the flow-line.

The filter arrangement as discussed above may also comprise a by-pass conduit (not shown) connected in parallel with the particle filter and a three-way valve, function associated with its downstream end enabling disconnection of the particle filter and leading gas through the by-pass conduit. This kind of by-pass conduit preferably comprises a particle filter of the same kind as the particle filter in the disconnected particle filter. The filter arrangement may also have further by-pass-conduits of the same type as described for the first one with the three-way valve function now being replaced with an at least three-way valve function.

Valves/valve functions and the like, and sensors and metering/measuring functions and the like of the inlet arrangement are in principle also part of the gas regulating arrangement and control unit, respectively, of the apparatus of the invention.

### Decomposition Unit (Decomposition Chamber and Heating Arrangements)

### Decomposition Chamber

The decomposition unit (105,205,305) comprises a) a flow-through decomposition chamber (106,206,306) in which the factual decomposition of the gaseous physiologically active agent shall occur, and b) a temperature regulating arrangement for supporting correct working temperature for the decomposition to occur.

In preferred variants of the invention the gaseous physiologically active agent is nitrous oxide which is a gas at normal pressures and temperature. It spontaneously and exothermally decomposes when heated to temperatures of about 600° C. or higher into nitrogen and oxygen in a molar ratio of 2:1 with significant amounts of undesired by-products such as nitrogen oxides other than nitrous oxide, i.e. NOₓ where x is an integer 1 or 2. It is known that by using a nitrous oxide decomposing catalyst the temperature for the decomposition can be lowered with formation of decreased amounts of NOₓ. In preferred variants when the gaseous physiologically active agent is nitrous oxide, the decomposition chamber (106,206,306) will contain a catalyst capable of decomposing nitrous oxide.

If the gas to be treated contains one or more other physiologically active gaseous agents, catalysts supporting decomposition of such agents may be included in a decomposition chamber of the inventive apparatus. Alternatively such other agents may be removed by adsorption as described elsewhere in this specification.

In preferred variants of the invention, a catalyst capable of decomposing the gaseous agent preferably is in the form of a porous bed filling up the volume of the decomposition chamber in which it is placed, e.g. the decomposition chamber (106,206,306). This kind of bed is porous in the sense that its porosity is sufficient for the gas to easily pass through. The bed may be in the form of a porous monolith or in the form of porous or non-porous particles packed to a bed. The volume, cross-sectional area and length of the bed/chamber (106,206,306) depend on desired capacity of the apparatus, intended flow, the efficiency of the catalyst, among others. Typical suitable volumes for the decomposition chamber are ≧0.5 dm³, such as ≧1 dm³ or ≧5 dm³ or ≧10 dm³ and/or ≦1000 dm³, such as ≦500 dm³ or ≦400 dm³ or ≦200 dm³, with preference for the interval 1-400 dm³, such as 10-200 dm³. The preferred geometric forms are cylindrical although other forms such as parallelepipeds may also be useful. It is often convenient to design the outer measures of the decomposition chamber including insulation material and the like so that the chamber unit can be passed intact through normal doors, i.e. having a cross-sectional area perpendicular to its length that corresponds to a circular design with a diameter of at most about 0.7 meter such as at most about 0.5 meter.

The flow direction through the chamber is typical along its length/height, in particular for cylindrical chambers. For vertical flow directions, it is believed that it will be preferred to have the inlet end at the lower end and the outlet at the upper end of the chamber (106,206,306).

The decomposition chamber including the catalyst, capacity of flow creating functions etc should be designed such that it is possible to enable residence times for gas flowing through the chamber to be within the interval ≦30 sec, such as ≦20 sec or ≦10 sec, such as ≦5 sec or ≦1 sec or ≦0.5 sec or more preferably ≦0.2 sec such as ≦0.1 sec. Residence time is the time during which the gas is in contact with the catalyst.

In variants of the invention utilizing a catalyst, the decomposition chamber is defined as the portion of the flow line located between the upstream end and the downstream end of the catalyst.

A suitable catalyst should support formation of harmless products with none or only trace levels of the agent remaining in gas leaving the decomposition unit (105,205,305) and/or chamber (106,206,306). This includes that the catalyst also should support none or only traces levels of undesired by-products in the flow downstream of the unit and/or chamber). In other words when the agent to be decomposed is nitrous oxide the harmless products are N₂ and O₂ with the undesired by-products being nitrogen oxides other than nitrous oxide as discussed below. The life time of the catalyst should be long with slow or no inactivation by moisture and/or other agents that may be present in air exhaled by patients connected to the apparatus. Suitable catalysts may be found amongst those that are effective for decomposing the gaseous physiologically active agent to harmless products or to acceptable levels or other products at temperature interval that should be within the interval of 200-750° C., typically within 350-550° C., such as within the interval of 400-500° C. For nitrous oxide this means to nitrogen and oxygen. The temperature interval at which a catalyst when used in the apparatus of the invention is effective in carrying out the decomposition to desired end products will in the context of the invention be called working or process temperature interval.

Trace levels of nitrous oxide refer to the level of nitrous oxide remaining in gas exiting the decomposition unit and/or chamber and as a rule are levels ≦4000 ppm, such as ≦1000 ppm or ≦500 ppm. Trace levels of nitrous oxide may alternatively and preferably refer to the level remaining in gas leaving the decomposition unit and/or chamber relative to the level in gas entering the chamber and preferably are ≧80%, preferably ≧90% or ≧95% ≧99%. The same intervals also apply to gas exiting the apparatus via the outlet arrangement.

Trace levels of nitrogen oxides other than nitrous oxide primarily refers to levels ≦2 ppm, such as ≦1 ppm or ≦0.5 ppm or ≦0.1 ppm or ≦0.05 ppm. The same intervals also apply to gas exiting the apparatus via the outlet arrangement. The most important nitrogen oxides to which these limits apply are NOₓ where x is an integer 1 or 2, i.e. the levels of NO, NO₂ and NO+NO₂.

The activity of preferred catalysts should be essentially independent of the absence or the presence of a halogenated anaesthetic agent in the gas entering the decomposition chamber. The expression “essentially independent” in this context means that for one kind of preferred catalysts it should be possible to keep the level of physiologically active agent, e.g. nitrous oxide, in gas exiting the decomposition chamber relative to its level in gas entering the same chamber below the limits discussed above for ≧a month, such as ≧a quarter of a year with preference for ≧one year, such as ≧two or more years. For anaesthetic gases containing nitrous oxide these limits in particular apply to gases containing at least one volatile anaesthetic agent selected from the group consisting of a) halogen-containing alkanes including in particular fluoroakanes such as halothane (2-bromo-2-chloro-1,1,1-trifluoroethane), b) fluoroethers such as isoflurane (1-chloro-2,2,2-trifluoroethyl difluoromethyl ether), sevoflurane (fluoromethyl 2,2,2-trifluoro-1-(trifluoromethyl)ethyl ether), enflurane (2-chloro-1,1,2-trifluoroethyl difluoromethyl ether) and desflurane (1,2,2,2-tetrafluoroethyl difluoromethyl ether), and c) other halogen-containing, in particular fluoro-containing, volatile anaesthetic agents. These anaesthetic agents are typically present at a concentration of ≦3%, such as ≦2% (v/v) in inhaled gas and/or in gas entering the apparatus.

In the cases of anaesthetic gases containing nitrous oxide, it may be advantageous to include an adsorption column for the anaesthetic gaseous agent upstream of the decomposition unit (105,205,305) or even upstream of the inlet end (102,202,302) of the flow line (101,201,301).

For exhaled air containing nitrous oxide with or without anaesthetic agents it may be appropriate to include an adsorption column for moisture upstream of the decomposition unit (105,205,305) or upstream of the flow line (101,201,301). See for instance publications cited under the heading “Background technology” with particular emphasis of U.S. Pat. No. 7,235,222 (Showa Denko K.K), WO 2006059606 (Showa Denko KK), WO 2002026355 (Showa Denko KK).

Nitrous oxide decomposing catalysts giving none or only trace levels of nitrogen oxides other than nitrous oxide are well known in the literature. See for instance U.S. Pat. No. 7,235,222 (Showa Denko K.K), WO 2006/059506 (Showa Denko K.K) and U.S. Pat. No. 4,259,303 (Kuraray Co, Ltd) which describe apparatuses for decomposing nitrous oxide in waste gas from health care units, and U.S. Pat. No. 6,347,627 (Pioneer Inventions, Inc) which describes an apparatus for the production of synthetic air. Patent publications specifically dealing with catalysts that can be used for the decomposition of nitrous oxide and VOCs, respectively, are numerous.

There are thus numerous catalysts that are expected to work for the decomposition discussed, with preference for the decomposition of nitrous oxide. Illustrative variants are oxidized noble metal catalysts supported on alumina including oxidized ruthenium on alumina. Other catalysts can be made from the other noble series metals, including rhodium, iridium, palladium, osmium, and platinum. Transition metal oxides, including cobalt, titanium, vanadium, iron, copper, manganese, chromium, and nickel oxides have also been shown to catalyze the nitrous oxide decomposition reaction. These metals can be supported on porous alumina, zirconia, or yttria substrates. In addition, crystalline zeolites having a structure type selected from the BETA, MOR, MFI, MEL, or FER IUPAC designations with the sodium or potassium ion-exchanged for one of the noble metals listed above should work. The catalytic active entity and/or the support may be in the form of particles.

For nitrous oxide decomposition, useful catalysts thus may be found amongst those that are referred to in U.S. Pat. No. 7,235,222 (Showa Denko K.K), WO 2006/059506 (Showa Denko K.K) and thus comprise: a) a support carrying at least one type of metal selected from the group consisting of magnesium, zinc, iron and manganese, possibly together with aluminum and/or rhodium, b) an alumina support carrying oxides of at least one type of metal selected from the group consisting of magnesium, zinc, iron and manganese possibly together with rhodium, or c) rhodium carried on a support formed of a spinel-type crystalline compound oxide with at least a portion thereof comprising aluminum together with at least one metal selected from the group consisting of magnesium, zinc, iron and manganese.

Preferred catalysts are particulate materials that comprise a catalytically active metal oxide, with preference for comprising either one or both of copper and manganese and/or a support material based on alumina with the content of metal oxide as discussed in the next paragraph. This in particular apply if the gaseous agent to be decomposed is nitrous oxide.

In the context of the invention the selection of suitable catalyst has been based on catalysts suitable for removing/decomposing volatile organic compounds (VOCs) in industrial offgases. It has thus been found that this group of catalysts contain efficient and economically favourable catalysts useful for nitrous oxide decomposition. Particular preferred catalysts of this type are likely to be found amongst those that are based on alumina supports in the form of particles and comprises a catalytically active combination of metal oxides, with preference for oxides of copper and/or manganese, typically in the range of 5-30% with preference for 11-17% (by weight). These catalysts also have the potential of decomposing VOCs of the kinds discussed above that may be present in the gas to be treated according to the invention.

### Temperature Regulating Arrangement Including Conventional Heaters and Heat Exchangers and Regenerative Heat Exchangers

The temperature regulating arrangement of the decomposition unit comprises a heating arrangent A (121a,221a,321a) for heating gas entering the decomposition chamber and typically also a cooling arrangement A (121b,221b,321b) for cooling hot gas exiting the decomposition chamber (106,206,306). The heating arrangement A and the cooling arrangement A are preferably forming a heat exchanger A (121,221,321) in which heat in gas leaving the decomposition chamber (106,206,306) is transferred and used to heat incoming gas which is about to pass through the decomposition chamber (106,206,306). This heat exchanger should preferably have an efficiency in the interval of 50-95% with preference for 70% or higher.

If a heat exchanger A (121,221,321) is present, the temperature regulating arrangement typically also comprises a second heating arrangement B (122,222,322) downstream of heat exchanger A. This second heating arrangement shall be capable of raising the temperature of gas leaving heat exchanger A to the process temperature for the desired decomposition. In other words heating arrangement B (122,222,322) shall be capable of securing the process temperature by compensating for possibly temperature deficiencies between the temperature obtained with heat exchanger A and a desired process temperature. Heating arrangement B (122,222,322) is typically an electrical heater, preferably integrated with the decomposition chamber (106,206,306), for instance immediately upstream of the decomposition chamber (106,206,306) and/or preferably placed within the chamber (106,206,306) with heating elements distributed along the flow direction. The effect of heating arrangement B (122,222,322) is typically lower if it is preceded by a heat exchanger compared to not being preceded by a heat exchanger. The effect of heating arrangement B in combination with a preceding heat exchanger should be sufficient for heating the chamber and incoming gases to a temperature within the process temperature interval. Typically the effect of a heating arrangement B is adjustable within a certain range with a maximal effect being ≧5 kW, such as ≧10 kW or ≧15 kW with typical upper limits being 100 kW, 50 kW, 40 kW or 30 kW irrespective of lower limit.

The decomposition unit (105,305) preferably also comprises an additional heat exchanger C (127,327) in which gas cooled in heat exchanger A (121,321) is further cooled by heat exchange to a temperature ≦100° C., such as ≦70° C. or ≦60° C. preferably with incoming gas before it is heated in heat exchanger A (121,321). To include this second heat exchanger is favourable with respect to energy input. A less economical variant is to use ambient air or some other external cooling medium in heat exchanger C.

Heat exchanger A (121,221,321) and heat exchanger C (127,227,327), if present, may be selected amongst different types. Either one or both of them may be a shell and tubular heat exchanger, a plate heat exchanger, a regenerative heat exchanger etc. The preference is for plate heat exchangers and regenerative heat exchangers. Plate exchangers are preferred to shell and tubular exchangers since they are available in compact format and with a high heat exchange efficiency. The compact format of plate exchangers makes them well-fitted for compact nitrous oxide decomposing apparatus. If a regenerative heat exchanger is included as heat exchanger A, then the second heat exchanger C often can be excluded.

Regenerative heat exchangers as applied to the present invention comprises that heat in the hot gas exiting the decomposition chamber is first transferred and stored in a heat absorber from which heat subsequently is transferred to incoming gas that is about to enter the decomposition chamber. This implies that for continuous processes of the type described in this specification there is needed two heat absorbers connected to the decomposition chamber and a 4-way valve function (preferably a 4 way rotor valve) with one way being connected to the downstream part of the flow line (outlet), one way to the upstream part (inlet), one way to one of the heat absorbers and one way to the other heat absorber. With this design it will be possible to cool gases exiting the decomposition chamber in one of the heat absorbers while simultaneously heat incoming gas in the other heat absorber and by switching the 4-way valve reversing the flow through the heat absorbers and the decomposition chamber so that heat absorbed during cooling is used to heat incoming gas. This switching is done in a cyclic repetitive mode.

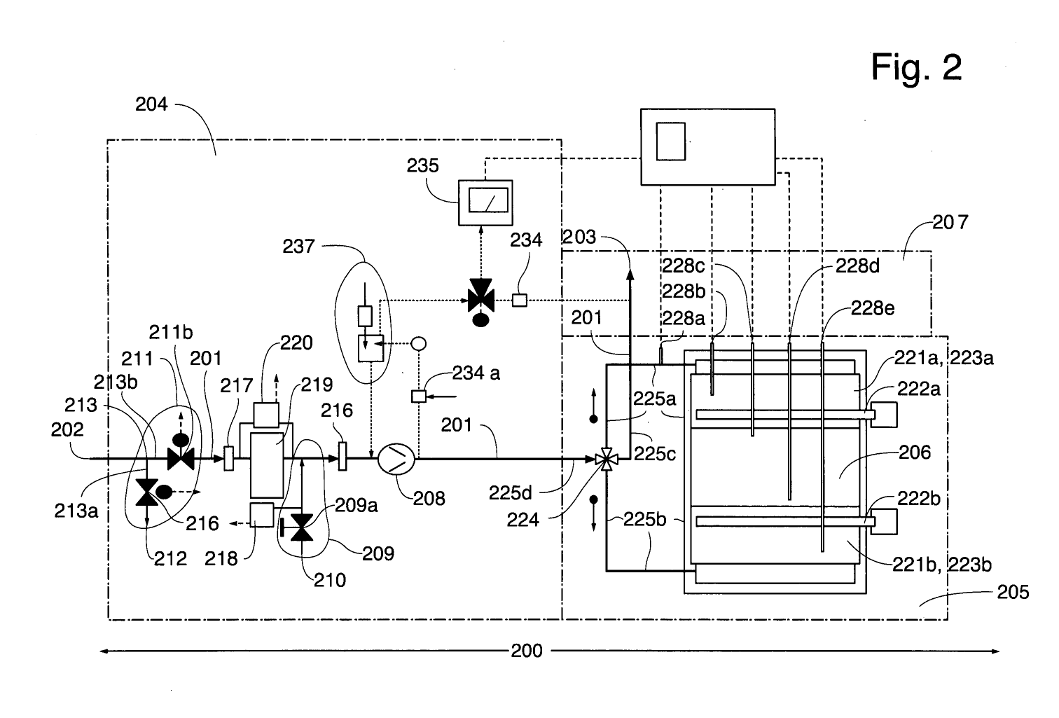

It is believed that regenerative heat exchangers will have a good potential to be preferred in the invention, e.g. as heat exchanger A, because they include variants that most likely will have advantages when constructing compact and space-saving decomposition units, for instance with necessary heating arrangements integrated with the decomposition chamber in one block. A regenerative heat exchanger that is useful in the invention could have the design outlined for the apparatus in FIG. 2 and comprise at least two separate heat exchangers (221a,b) each of which contains a heat absorber (223a,b), at least a multi way valve function (224) permitting reversal of flow through the decomposition chamber (206) and conduits (225a,b,c,d) linked together in a way enabling cycles comprising the steps of: i) switching the valve function (224) to a first position so that hot gas will leave the decomposition chamber (206) through a first transport conduit (225a) containing a first heat exchanger (221a) with heat absorber (223a), whereafter the obtained cooled gas is transported in a common outlet conduit (225c) further downstream into the outlet arrangement (not shown), ii) switching the valve function (224), preferably a 4-way rotor valve, to a second position so that incoming gas from the inlet arrangement (204) via the common inlet conduit (225d) will pass through the first conduit (225a) containing the first heat exchanger (221a) with heat absorber (223a) thereby becoming heated before passing through and leaving the decomposition chamber (206) through a second conduit (225b) containing a second heat exchanger (221b) with heat absorber (223b) whereafter the now cooled gas is transported in the common outlet conduit (225c) further downstream into the outlet arrangement, iii) switching the valve function (224) to the first position thereby initiating repetition of the steps (i)-(iii) (=one cycle). Each of the heat absorber and the corresponding part of a transport conduit (225a,b) defines a heat exchanger (221a,b). Between each heat exchanger (221) and the decomposition chamber (206) there preferably is a heating arrangement (222a,b). This heating arrangement (222) is “on” when gas heated in a heat exchanger (221) passes through in order to support the desired process temperature and is “off” when hot gas from the decomposition chamber (206) passes. In preferred variants the heat exchangers (221a and b) and heating arrangements (222a and b) (if present), and the decomposition chamber are preferably integrated into the same block as illustrated in FIG. 2. Typically each cycle will comprise a period of time in the interval of about 0.5-5 minutes with switching at each half and full time period, for instance a period of two minutes with switching the valve function (224) every second minute.

Although not preferred the 4-way rotor valve mentioned above may be replaced by different x-way valve combinations resulting in a 4-way valve function at the junction of the four conduits (225a-d) (x=1, 2 or 3).

The heat absorber (223a or 223b) in the preceding paragraph may be a porous bed of heat absorbing material through which the hot gas and the cold incoming gas alternatingly are passing. This bed may be a porous monolith or a bed of solid non-porous particles packed to a bed. The bed may or may not be catalytically active in decomposing the gaseous physiologically active agent, e.g. nitrous oxide. Its absorption and adsorption capacity for the gaseous agent should be as low as possibly (=insignificant) since this would minimize the volume of the puff discussed below (minimum volume is the void volume of the heat adsorbing bed).

The term “regenerative heat exchanger” above includes variants containing two or more heat exchangers of the same kind as heat exchangers (221a and 221b) above and alternate use of them in cycles.

We have realized that regenerative heat exchangers when used as described above will lead to effluent gas containing repetitive small puffs of the gaseous agent to be degraded. The occurrence of repetitive puffs will decrease the efficiency of the decomposition unit and the apparatus. A function for neutralizing the puffs emanating from the use of a regenerative heat exchanger would be beneficial (puff filter or puff-neutralizing function)

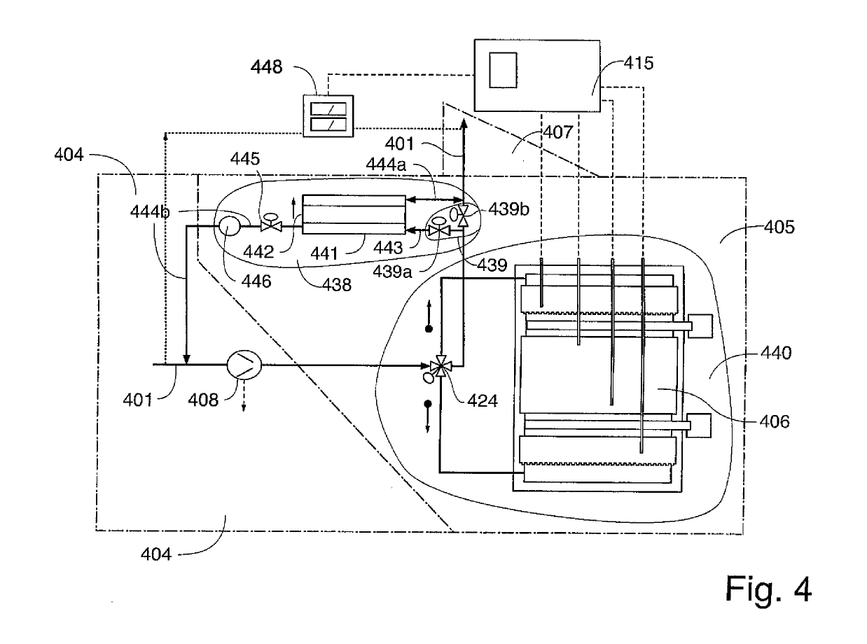

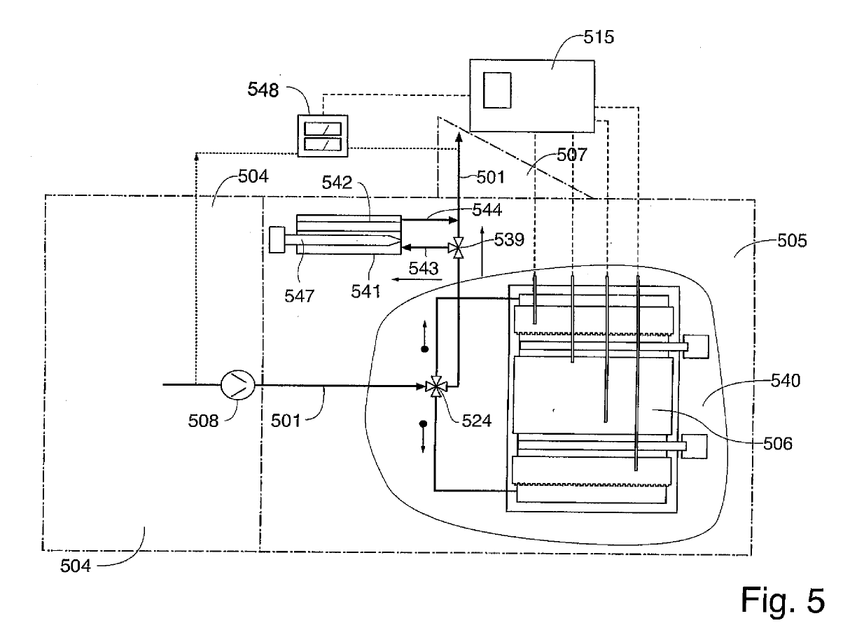

Preferred puff filters are illustrated in FIGS. 4 and 5 (variants 1 and 2, below). In addition to a puff filter (438,538), both figures shows a part of the flow line (401,501), a part of the inlet arrangement (404,504), the decomposition unit (405,505), the outlet arrangement (407,507) and parts of the control unit (the control block (415,515) and a nitrous oxide sensor arrangement (441,442)). The decomposition unit comprises the regenerative heat exchanger (440,540), the decomposition chamber (406,506) and the puff filter (438,538). Other parts of the apparatuses may be as outlined elsewhere in this specification. See for instance FIGS. 1-3.

A puff filter typically has a 3-way valve function permitting selective diversion of puffs into the puff filter. As illustrated in FIGS. 4 and 5 this valve function (439,539) is placed downstream of the regenerative heat exchanger (440). When no puffs are passing the position of the puff filter (438,538), the 3-way valve function (439,539) is in by-pass position. Every time a puff is about to pass, the 3-way valve function is switched to the puff diverting position, the puff diverted into the puff filter and the valve switched back to the by-pass position. The gaseous agent to be degraded in the puff filter may then be neutralized in a number of different ways. FIGS. 4 and 5 represent two main approaches (adsorption/desorption and catalytic degradation, respectively). The 3-way valve function may be composed one 3-way valve or two 2-way valves as discussed below.

The puff filter (438) in FIG. 4 comprises a container (441) with a porous adsorbent (442) which is capable of adsorbing the gaseous agent when the puff passes through the adsorbent (flow direction indicated with an arrow). The adsorbent is a carbon filter in the variant preferred at the filing of this specification. The adsorption for the gaseous agent should preferably be reversible thereby permitting regeneration of the adsorbent, e.g. by flowing a gas not containing or being low, such as depleted, in nitrous oxide through the filter. The direction of flow during desorption is preferably reversed relative to the direction during adsorption. The puff filter (438) has
a) an inlet conduit (443) for diverting puffs from the main flow line (401) to the container (441), and
b) two outlet conduits (444a,b) for transporting gas out from the container (441).

The inlet conduit (443) is at one end connected to the upstream end of the container (441) (=upstream end of the adsorbent) and at its opposite end to the flow line via a 3-way valve function (439). The inlet conduit (443) is used for diverting puffs into the container via the 3-way valve function (439). This 3-way valve function may comprise two 2-way valves (439a and 439b, respectively) with one of the valves placed in the inlet conduit (443) and the other one in the flow line (401) upstream of the position where the inlet conduit (443) is connected to the flow line (401). Alternatively the valve function may be a 3-way valve (539) as illustrated in FIG. 5.

One of the outlet conduits (444a) is at one end (1^{st} end) connected to the downstream end of the container (441) (=downstream end of the adsorbent) and at its other end (2^{nd}) to the flow line (401) at a position downstream of the inlet conduit (443). The other outlet conduit (444b) is at one end connected to the upstream end of the container (441) (=upstream end of the adsorbent) and at its other end to the flow line (401) at a position close to and upstream of the function (408) for creating and changing flow (compare FIG. 2). The first outlet conduit (444a) has two main uses: a) returning puffs depleted in the gaseous agent to the flow line (401), and b) diverting a part of the flow in the flow line (401) to pass through the adsorbent (442) thereby desorbing the adsorbed gaseous agent and returning it back into the flow line via the second outlet conduit (444b). At this stage the flow direction through the adsorbent (442) is reversed relative to the flow direction used during the adsorption. The outlet conduit (444b) comprises a 2-way valve (445), preferably a stop-flow valve, and preferably also a function (446) (preferably a blower) for creating and/or changing the flow used for desorption of the gaseous agent from the adsorbent (442) and pass it back to the flow line (401) as discussed elsewhere in this specification.

The desorbing gas may also be transported to the outlet end of the container (441) by a conduit (not shown) that at one end is connected at the outlet end of the container and at its other end is in communication with a source for desorbing gas (not shown). The puff filter (438) works in the following way:
Step 1 (adsorption): The gaseous agent in a puff is bound to the adsorbent when the puff is passing through the container (441) and returned back to the main flow line (401) via outlet conduit (444a).
   3-way valve function (439): inlet conduit (443) is open (valve 439a open), flow line (401) closed for by-pass of flow (valve 439b closed).
   2-way valve (445) closed.
Step 2 (desorption): The gaseous agent in the adsorbent (442) is released from the adsorbent by flow diverted by sucking part of the flow in the main flow line (401) into the outlet conduit (444a), through the adsorbent (442) and through the outlet conduit (444b) to the flow line (401) downstream of function (408). Sucking is caused by subpressure created by function (408) and function (446).
   3-way valve function (439): inlet conduit (443) is closed (valve 439a closed), flow line (401) opened for by-pass of flow (valve 439b open).
   2-way: valve (445): open.
Step 3 (disconnection of the puff filter, not imperative): Flow is by-passing the puff filter (438). No diversion of flow.
   3-way valve function (439): inlet conduit (443) is closed (valve 439a closed), flow line (401) opened for by-pass of flow (valve 439b open).
   2-way valve: closed
Step 4 and onwards: Repetitive cycles, each of which comprises in sequence steps 1, 2 and 3 (optional).

The puff filter (538) in FIG. 5 comprises a container (541) with a porous bed containing a catalyst material (542) which is capable of degrading the gaseous agent when the puff passes through the bed (flow direction indicated with an arrow). The catalyst material is typically selected according to the same principles as outlined for the catalyst material in the decomposition chamber (506). The puff filter (538) has a) an inlet conduit (543) for diverting puffs from the main flow line (501) to the container (541), b) an outlet conduit (544) for transporting gas out from the container (541) and c) a heater (546) for heating the incoming puff and the catalyst material to a temperature selected as outlined for the working temperature of the decomposition chamber (506) as discussed for decomposition chambers in general elsewhere in this specification. The inlet conduit (543) and the outlet conduit (544) are connected to the container (541) and to the flow line (501) as in FIG. 4.

The puff filter (538) works in the following way:
Step 1 (decomposition, flow in flow line is diverted through the puff filter): The gaseous agent to be degraded in a puff is decomposed by the catalytic material in the bed (542). The puff is flowed through the inlet conduit (543) and the container/bed and returned back to the main flow line (501) via outlet conduit (544a). Flow entering the puff filter and the catalyst material is heated by heating function (547)
   3-way valve function (539): inlet conduit (543) is closed (valve 539a closed), flow line (501) opened for by-pass of flow (valve 539b open).
Step 2 (flow by-passing the puff filter, optional but preferred): Gas flow containing no puff of the gaseous agent is by-passing the puff filter.
   3-way valve function (539): inlet conduit (543) is closed, flow line (501) is open for by-pass.
Step 3 and onwards: Repetitive cycles each of which comprises in sequence steps 1 and 2.

In every cycle of a puff filter, step 1 should last for ≧0.5 sec, such as ≧1 sec and/or ≦12, such as ≦10 sec and typically be within the interval of 1.5-5 sec, such as within 2-3 sec, and step 2 for 1-8 minutes, typically 1-5 minutes. Independent of the individual steps the total time for a cycle corresponds to the time a heat exchanger (521a or 521b) is used in a cycle for the regenerative heat exchanger. See elsewhere in this specification.

If and when the gaseous agent in a puff entering the puff filter is returned back to merge with the main flow (e.g. as in the variant of FIG. 4), it is important to balance the system such that no puffs of the gaseous agent is leaked out at positions that are open to ambient atmosphere, for instance at the inlet valve function (209, FIG. 2). Subpressure at inlet valve function (209, FIG. 2) shall be maintained meaning that the return flow should be sufficiently low for not disturbing the balance, typically ≦25%, such as ≦15%, with preference for ≦10% or ≦5% of the main flow at the merging position. The balancing is under the control of the control unit which will cause function (408) (e.g. a blower) to increase the main flow in flow line (401) if the subpressure at the merging point and/or at an inlet valve function (209, FIG. 2, if present) is disappearing. The merging position should upstream of the regenerative heat exchanger (440,540) with the preference for upstream of function (408,508) (e.g. a blower) for creating and changing flow. In the case an inlet valve function (209, FIG. 2) is present the merging position is preferably downstream this function. Compare FIGS. 2 and 4.

Returning puffs depleted in the gaseous agent in the puff filter to the flow line (401,501) may take place at in principle any position along the flow line provided the system is balanced as discussed above. The preference is for positions downstream of the regenerative heat exchanger (440,540) with the highest preference for downstream of the puff filter (438,538). Alternatively, gas in puffs depleted in the gaseous agent in the puff filter may also be guided directly to ambient atmosphere in a flow line (not shown) which is separate from the main flow line (401, 501).

A third possibility for a puff filter is to collect one or more puffs in an expandable container linked to the main flow line downstream of the regenerative heat exchanger whereafter the gas in the container is returned back to the flow line at a position upstream of the regenerative heat exchanger, with preference for the positions given for the variant discussed for FIG. 4. Further possibilities are likely to exist.

The decomposition unit preferably comprises a temperature sensor (128 a,b,c,d . . . , 228 a,b,c,d . . . , 328 a,b,c,d . . . ), typically in the form of a thermo element, at one, two, three, four or more positions along the flow line within the decomposition unit (105) for measuring the temperature at these positions. Suitable positions in the apparatus of FIG. 1 are i) between heat exchanger A and heating arrangements B (121a and 122, respectively)(128a), ii) between heating arrangement B (122) and the decomposition chamber (106) (128b), iii) in the decomposition chamber (106) (preferably several positions distributed along the flow direction, not shown), and iv) between the decomposition chamber (106) at the optional heat exchanger C (128c), v) in the downstream part of the of the decomposition unit (105) (128d), for instance downstream of the heat exchanger C (127). Temperature sensors (128 a,b,c,d . . . ) are also part of the control unit.

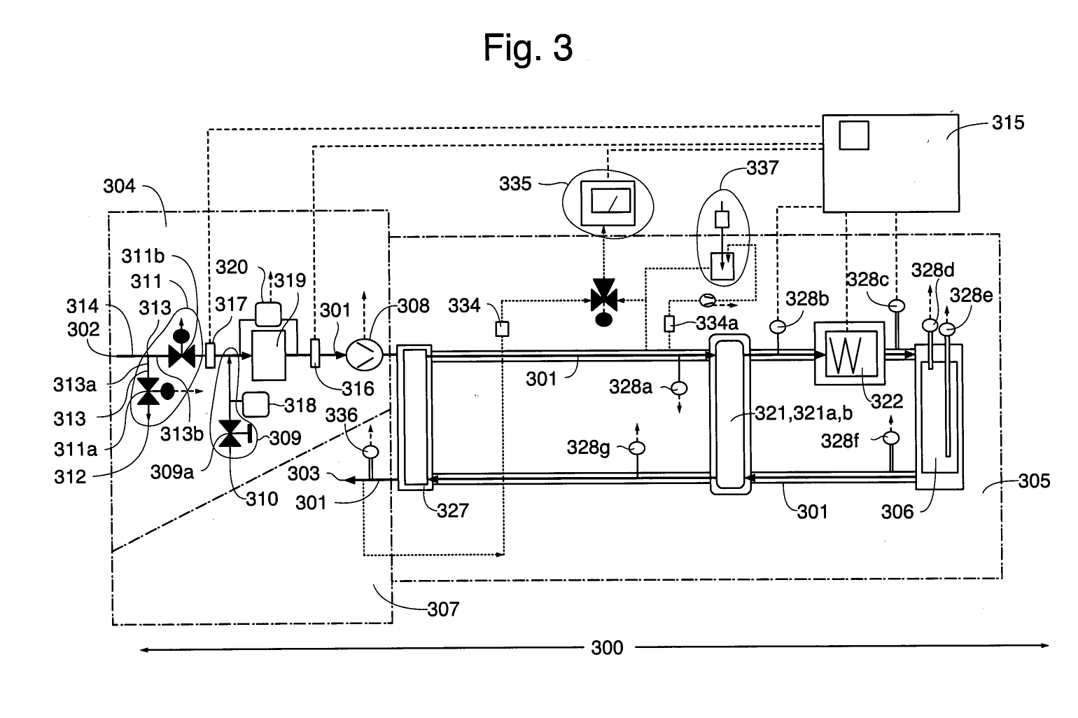

The positions of the temperature sensors for other variants of the apparatus are apparent from FIGS. 2 and 3.

Valves/valve functions and the like, and sensors and metering/measuring functions and the like of the decomposition unit are in principle also part of the gas regulating arrangement and control unit, respectively, of the apparatus of the invention.

### Outlet Arrangement

The outlet arrangement (107,207,307) comprises the downstream part of the flow line (101,201,301).

In the case the level of nitrogen oxides, such as NOₓ, is unacceptably high it will be advantageous to wash the waste gas with an alkaline aqueous medium, for instance in a scrubber arrangement comprising the scrubber as such (129), supply conduits for alkali (130) and water (131), waste water conduit (132), pH sensor (133) etc. However the use of scrubbers and other arrangements meaning washing of the gases in the outlet arrangement in most cases will render it difficult to design compact apparatus. This means that it is more optimal to select catalysts supporting acceptable levels of the physiologically active agent and its decomposition products in the waste gas thereby promoting a compact design.

A scrubber, e.g. of the type described in the preceding paragraph, may also act as a cooling arrangement.

The outlet arrangement may also comprise a temperature sensor (136a,b . . . , 236a,b . . . 336a,b . . . ), e.g. in the form of a thermo element at one, two or more positions. Typical positions in the apparatus of FIG. 1 are in the outlet end (103) or elsewhere in the outlet part (107) of the flow line (101). A temperature sensor in the outlet part may coincide with a temperature sensor at the downstream end of the distribution unit (105).

Suitable positions for other variants of the apparatus of the invention are given in FIGS. 2 and 3.

The outlet arrangement may also comprise a sensor device for measuring nitrogen oxides other than nitrous oxide and/or a sensor device for measuring nitrous oxide. Each of these devices in principle contains a sampling function (134,234,334) and an analysator (135,235,335) comprising a metering device. A sampling function (134,234,334) typically is connected to the flow line (101,201,301) at a position downstream of the decomposition chamber (106,206,306) and then upstream or downstream of heat exchanger C (127,327), if present. The preferred position is further downstream, such as in the outlet part of the flow line, i.e. in the outlet arrangement (105,205,305), such as downstream or upstream of a scrubber (129) etc if present.

A simple variant of a sensor variant for NOₓ comprises a pH-sensor in the water of a scrubber.

The sensor arrangement for nitrous oxide preferably also comprises a sampling function (134a,234a,334a) connected to the flow line at a position upstream of the decomposition chamber (106,206,306); with preference for upstream (FIGS. 1 and 2) of or within (FIG. 3) the decomposition unit (105,205,305). The connection of this sampling function to the flow line is typically also downstream of a) a valve function (109,209,309) for inlet of external gas for regulating gas pressure in the flow line of the inlet arrangement and/or b) a particle filter (119,219,319) and/or c) a function (108,208,308) for regulating flow through the decomposition chamber. This sampling function (134a,234a,334a) may be associated with an analysator including a metering device which is separate from the analysator (135,235,335) associated with the downstream sampling function (134,234a,334a) for nitrous oxide, but preferably the two analysators for the two sampling functions coincide, i.e. the same analysator (135,235,335) is used for the two sampling functions. The level of nitrous oxide downstream (134,234,334) of the decomposition unit should be at least 80%, such as at least 90%, with preference for at least 95% or at least 99%., of the level upstream (134a,234a,334a) of the decomposition unit (106,206,306). Therefore the gas sampled at the upstream position is typically diluted with air in separate dilutor (137,237,337) to a concentration comparable with the concentration at the downstream sampling position before nitrous oxide is measured.

Valves/valve functions and the like, and sensors and metering/measuring functions and the like of the outlet arrangement are in principle also part of the gas regulating arrangement and control unit, respectively, of the apparatus of the invention.

### Method Aspects of the Invention

These aspects comprise the use of an apparatus as defined above.

The typical patient is undergoing surgery, dental care, delivering a child etc, e.g. of the patients connected to the apparatus at least one is woman undergoing delivery of a child, at least one is undergoing surgery, at least one is undergoing dental care, at least one is undergoing etc.

Two variants of the method of the invention are: a) treating exhalation air containing a halo-containing anaesthetic agent, and b) treating exhalation air which is devoid of a halo-containing anaesthetic agent. Nitrous oxide is typically present as a physiologically active agent in both variants, i.e. as an anaesthetic and/or analgesic agent. For each variant it is appropriate to adapt the apparatus as discussed above.

A main method aspect (1^{st}) is a method for the decomposition of a gaseous physiologically active agent, such as nitrous oxide, present in gas derived from air exhaled by a plurality of patients (one, two or more) inhaling a gas containing the agent. This method comprises the steps of:
i) providing a decomposition apparatus of the kind defined under the heading “Background Technology”, and
ii) connecting at least one of the patients to the apparatus,
iii) flowing said gas from the patients connected to the apparatus through the inlet arrangement and through the decomposition unit at conditions, including heating to the process temperature, enabling decomposition of said agent in said decomposition chamber, and
iv) flowing gas exiting the decomposition unit through the outlet arrangement.

The characterizing feature is
a) that the apparatus comprises a gas regulating arrangement permitting adjustment of flow of gas through the apparatus to be continuously maintained independent of number of patients connected to the apparatus, and
b) that step (iii) comprises changing the number of patients connected to the apparatus at least once to zero while maintaining flow through the apparatus and heating of the decomposition chamber, possibly to a lower temperature compared to the process temperature for decomposition, and/or
c) that step (iii) comprises changing the number of patients connected to the apparatus at least once without the number becoming zero, preferably while adjusting the flow to a higher value if the number is increased and to a lower value if the number is decreased and maintaining decomposition conditions in the decomposition chamber.

The characterizing feature (a) above means that the gas regulating arrangement preferably comprises A) a gradually adjustable function, such as a blower, for adjusting the flow of gas entering the decomposition chamber (see above), and B) preferably an inlet valve function permitting adjustment of the gas pressure upstream of the position of said gradually adjustable function (see above). At least one of these two features is preferably combined with the presence of the control unit described above, for instance as in the originally filed claim 3.

Adjustment and maintaining of flow is made by the control unit as described above.

Another main method aspect (2^{nd}) comprises steps (i)-(iv) of the 1^{st} main method aspect with the characterizing feature being the characterizing feature of the 2^{nd} main apparatus aspect.

Still another main method aspect (3^{rd}) comprises steps (i)-(iv) of the 1^{st} main method aspect with the characterizing feature being the characterizing feature of the 3^{nd} main apparatus aspect.

A subaspect of a main method aspect has typically as charactering feature a characterizing feature of one or more of the various features described for the method and/or apparatus aspects. A feature defining a functionality (function) may then be combined with a step utilizing the functionality.

### Best Mode

The best modes of the invention at the priority date was considered to be according to FIG. 3 as used in the experimental part. The incorporation of a regenerative heat exchanger, for instance as illustrated in FIG. 2, with preference as outlined in FIG. 4, has during the priority year been found to be favourable with respect to energy balance and compactness of the apparatus.

The invention is further defined in the appended claims which are an integrated part of the specification.

### EXPERIMENTAL PART

### Example 1

The apparatus is according to FIG. 3. Heating arrangement B (322, =heater) is integrated with the decomposition chamber (306) and adjustable in at least 5+5+5+3+2 steps (total 20 KW). Heat exchanger A (321) and heat exchanger C (327) are plate heat exchangers (Aircross 29 from Airec AB, Malmö, Sweden). The catalyst is a VOC catalyst (Metox 3) from Stonemill, Hasslarp, Sweden, and has a process temperature interval of 480-500° C. for decomposition of nitrous oxide. The decomposition chamber (306) has a height of 0.85 m and a diameter of 0.65 m with a vertically downward flow direction. A temperature sensor in the form of a thermo element is located at, six positions (328a,b,c,d,e,f). See FIG. 3. Temperature sensor (328d) in the inlet part of the catalytic bed is the controlling sensor for the heater. The valve (309a) for inlet of air is manually adjustable.

### Controlling the Process Flow:

The process flow rate through the decomposition unit is controlled relative to the incoming flow by the aid of a) a subpressure sensor (318), which measures the subpressure at the inlet valve (309a), b) the opening to ambient atmosphere of inlet valve (309a), and c) the speed of blower (308). The blower (308) and the opening of inlet valve (309a) are initially set to give a desired subpressure at sensor (318) for a normal rate of the incoming gas flow containing nitrous oxide. Typical subpressure values are found in the interval of −1 Pa to −150 Pa, e.g. −5 Pa, −10 Pa, −50 Pa eller −100 Pa.

Of importance for controlling the process flow in the flow line (301) is also the two flow sensors (317) and (316) located upstream and downstream, respectively, of the inlet valve function (309). The difference in measured values for these two sensors will give the influx rate of air via inlet valve (309a). This flow can alternatively be measured by a flow sensor in the conduit containing the valve (309a) (not shown).

The design with an inlet valve (309a) in free communication with ambient atmosphere (310) and subpressure at the subpressure sensor (318) will secure that nitrous oxide will pass into the flow line (301) of the apparatus and not exit the system via the inlet valve (309a). The design will also secure that the process flow in the apparatus will remain undisturbed even if there are quick and uncontrolled changes in the incoming flow that the blower (308) cannot manage.

During operation at a fixed incoming gas flow the blower (308) is set to give the preset target subpressure at subpressure sensor (318).
When incoming flow is increased, the subpressure at subpressure sensor (318) will decrease. The control unit will speed up the blower which means that the flow within the flow line will increase and the subpressure will restore to the preset target subpressure. This situation is applicable to cases in which the number of patients connected to the apparatus is increasing.
When incoming flow is decreasing, the subpressure at the subpressure sensor (318) will increase. The control unit will slow down the blower which means the flow within the flow line will decrease and the subpressure restore the preset target subpressure. This situation is applicable to the situation when the number of patients connected to the apparatus is decreasing.

An alternate way to control the process flow is to set a preset target value for the flow difference measured by flow sensors (316) and (317). When the incoming gas flow is increasing, the difference will decrease. The control unit then will speed up the blower restoring the flow difference to the target value. When the incoming flow is decreasing the flow difference will increase and the control unit will speed up the blower thereby restoring the flow difference to the preset target value. Suitable target values for the flow difference may be found in the interval of 1-70 m³/h, such as 2-30 m³/h, or 1-50%, such as 3-20% of the time-averaged flow rate of the incoming flow.

It is also possible to control the flow by combining the two alternatives. The first alternative is preferred.

Starting up: The blower (308) must be on and give a predetermined flow through the apparatus in order to start the heater (322). The flow is measured by flow sensor (316) and the control unit will not allow the heater (322) to be started until a certain minimum flow is at hand (threshold value). Valve (311a) is opened. Valve (311b) and the valve (309a) for inlet of air are closed. The heater (322) is now turned on in 5+5+5+3+2 steps such that overheating is avoided with maximum temperature being 550° C. which is controlled by sensor T2 (328d). When reaching a stable temperature within the working interval the catalyst is ready to receive patient-derived gas.

Normal working without change of the number of patients: The gas flow is adjusted by the use of the blower (308) via the pressure sensor (318) in the inlet arrangement (303) to be above a certain threshold flow which is controlled by the flow sensor (316) while simultaneously keeping a certain preset subpressure in the flow channel at subpressure sensor (318). Disturbances in incoming flow is taking care of by the control functions as discussed above.

Closing down the apparatus: The blower (308) is on until the temperature at the temperature sensor (328d) is <250° whereafter valve (311a) is opened and valve (311b) is closed.

### Alarm

Alarms leading to closing down of the apparatus, preferably automatically: a) the flow measured by the flow sensor (316) becomes below the preset threshold value, b) a too low or too high subpressure level compared to the preset value, and c) the temperature at temperature sensor (328d) is outside the working temperature interval etc. For alternative c) the closing-down procedure comprises turning off the heater (322) and then closing the valve (311a) followed by turning off the blower (308) when the temperature at sensor (328b) is <250° C. whereafter valve (311b) is closed.

Alarms not leading to closing down: a) A too low relative reduction level of nitrous oxide, typically below 90% downstream of the decomposition chamber (306) (=a too high relative level of nitrous oxide at the same position, typically above 10%), b) a too high level of nitrogen oxides other than nitrous oxide downstream of the decomposition chamber (for acceptable levels see elsewhere in the specification), c) the pressure drop sensor (320) indicates that the filter is clogged and needs replacement, etc.

Service/work in the apparatus: Valve (311a) is opened, valve (311b) closed, and the heater (322) and the blower (308) turned off.

Replacement of particle filter: The apparatus is working at the minimum value for flow at flow sensor (316). The valve (309a) for inlet of air is fully opened, valve (311a) is opened and valve (311b) is closed. After filter replacement valve (311b) is closed, valve (311a) is opened and valve (309a) for inlet of external air is closed. The apparatus is now ready to receive patient-derived gas.

What has been said in the experimental part about controlling the flow and alarming are also applicable to other important variants as for instance those of FIGS. 1 and 2.

### Example 2

### Regenerative Heat Exchanger Linked to a Puff Filter

The apparatus is the same as described in FIG. 2 except that a puff filter, which contains containing a nitrous oxide adsorbent, is connected downstream of the regenerative heat exchanger as outlined in FIG. 4.

Nitrous oxide adsorbent (442): 10 L particles of extruded coal based activated carbon (Exosorb® BXB (diameter 3 mm), Jacobi Carbon AB, Varvsholmen, Kalmar, Sweden).

Heat absorbers (223a och 223b): Each contains 50 L of Duranit® Inerta kulor ¼″ (Christian Berner AB, P.O. Box 88, SE 435 22 Mölnlycke, Sweden/Vereignete Fullkörper Fabriken GmbH, Postfach 552, D-56225 Ransbach-Baumbach, Germany).

Decompositon chamber: The same catalyst material as in example 1.

Time per step of a regenerative cycle in the heat exchanger: 120 sec between two consecutive switches of valve (424) (=maximal time for adsorption plus desorption in puff filter).

Flow in main flow (401): 60 m³/h through regenerative heat exchanger (440) (=17 L/sec)

Adsorption step: Forward flow through puff filter (438) is 17 L/sec during about 3 sec (=51 L). Valve (439a) is open and valves (445 and 439b) are closed.

Desorption step: Reversed flow 2 L/sec not containing nitrous oxide during 120 sec minus 3 sec=117 sec. Valve (439a) is closed and valves (445 and 439b) are open. Based on experiments at 2 L/sec, there is required 120 L gas depleted in nitrous oxide (depleted in the experiments ment reduction of the level of to 5% in the decomposition chamber (406) to desorb the nitrous oxide adsorbed during the previous adsorption step. It follows that desorption is completed after about 60 sec which is more than sufficient compared to 117 sec available. Depleted in the experiments mentioned above means a reduction in the level of nitrous oxide to 5% of the starting level.

The function (408) for creating and changing flow in the flow line (401) can be balanced to secure a predetermined target subpressure value at the inlet valve (209, FIG. 2) by the use of the control unit. The desorption flow 2 L/sec is sufficiently low compared to the flow in the main flow line (401) (17 L/sec) for maintaining this balancing. Leakage of nitrous oxide to ambient atmosphere via inlet valve function (209, FIG. 2) is not possible as long as the target subpressure at the inlet valve is maintained.

While the invention has been described and pointed out with reference to operative embodiments thereof, it will be understood by those skilled in the art that various changes, modifications, substitutions and omissions can be made without departing from the spirit of the invention. It is intended therefore that the invention embraces those equivalents within the scope of the claims which follow.

1.-15. (canceled)

16. An apparatus for decomposition of nitrous oxide present in exhaled air which is diluted with normal air and is derived from one or more patients inhaling a gas containing nitrous oxide, comprising a gas flow line along which is located in downstream order
a) an inlet arrangement which in the upstream direction is capable of being placed in simultaneous gas flow communication with said one or more patients,
b) a decomposition unit in which there is a flow-through decomposition chamber in which nitrous oxide is to be decomposed,
c) an outlet arrangement, and
d) a gas regulating arrangement comprising a gradually adjustable blower for adjusting the flow of gas entering said decomposition chamber.

17. The apparatus of claim 16, wherein said gas regulating arrangement comprises an inlet valve function which is associated with said flow line in said inlet arrangement and is placed upstream of said blower, and is configured to provide an adjustable opening to ambient atmosphere.

18. The apparatus of claim 17, further comprising a control unit comprising sensors configured to measure at least one of
a) flow through said inlet arrangement with a sensor placed upstream of said blower and downstream of said inlet valve function, and
b) subpressure in said flow line of said inlet arrangement with a sensor placed in association with said inlet valve function and upstream of said blower.

19. The apparatus of claim 18, wherein said gas regulating arrangement is capable of
a) maintaining, independent of number of patients connected to said apparatus, gas flow through said decomposition chamber while said decomposition chamber is heated, and
b) gas subpressure within a preset interval around a desired value in a part of said flow line of said inlet arrangement, and said control unit is capable of:
i) measuring and checking said gas flow at a position upstream of said decomposition chamber, and
ii) adjusting said flow to be above or equal to a preset flow threshold value.

20. The apparatus of claim 18, wherein said gas regulating arrangement is capable of
a) maintaining, independent of number of patients connected to said apparatus, gas flow through said decomposition chamber while said decomposition chamber is heated, and
b) gas subpressure within a preset interval around a desired value in a part of said flow line of said inlet arrangement, and said control unit is capable of:
i) measuring and checking subpressure of gas at a position upstream of said decomposition chamber, and at least one of:
ii) adjusting said gas subpressure to be above or equal to said preset gas subpressure threshold value,
iii) adjusting said gas subpressure to be within said preset subpressure interval, and
iv) adjusting said gas subpressure to be equal to said preset desired subpressure value.

21. The apparatus of claim 16 wherein said decomposition chamber contains a catalyst for the decomposition of nitrous oxide to N₂ and O₂ enabling at least one of i) the level of nitrous oxide downstream of said decomposition unit to be ≦1000 ppm and ii) the level of NOₓ downstream of said decomposition unit to be ≦2 ppm where x is 1 or 2.

22. The apparatus of claim 16 wherein said decomposition chamber contains a catalyst for the decomposition of nitrous oxide to N₂ and O₂ selected amongst catalysts which are capable of degrading volatile organic compounds VOC.

23. The apparatus of claim 22, wherein said catalyst is based on an alumina-support in the form of particles and comprises a catalytically active combination of metal oxide selected from the group consisting of oxides of manganese and copper.

24. The apparatus of claim 16, wherein said decomposition chamber contains a catalyst for the decomposition of nitrous oxide to N₂ and O₂ selected amongst catalysts which comprise a support as a carrier for oxide of at least one metal selected amongst magnesium, zinc, iron and manganese.

25. The apparatus of claim 16, wherein said decomposition chamber contains a catalyst for the decomposition of nitrous oxide to N₂ and O₂ supporting that the relative reduction level of nitrous oxide downstream of said decomposition chamber is not ≦90%.

26. The apparatus of to claim 16, wherein said decomposition unit comprises
a) a heat exchanger A in which heat in gas exiting said decomposition chamber is used to heat gas that is about to enter said decomposition chamber, and
b) a heating arrangement B between said heat exchanger A and an upstream end of said decomposition chamber, wherein said heat exchanger A is a regenerative heat exchanger.

27. The apparatus of to claim 26, wherein said heating arrangement B is at least partially integrated with said decomposition chamber.

28. The apparatus of claim 26, wherein said regenerative heat exchanger is configured to first transfer and store heat in the hot gas exiting said decomposition chamber in a heat absorber from which heat subsequently is transferred to incoming gas that is about to enter said decomposition chamber.

29. The apparatus of to claim 26, wherein said regenerative heat exchanger comprises
a) at least two separate heat exchangers each of which contains a heat absorber,
b) at least a multi way valve function permitting reversal of flow through the decomposition chamber, and
c) conduits linked together enabling operation cycles of said regenerative heat exchanger in the form of:
i) switching said valve function to a first position so that hot gas will leave said decomposition chamber through a first transport conduit containing a first heat exchanger with heat absorber, whereafter the obtained cooled gas is transported in a common outlet conduit further downstream into said outlet arrangement,
ii) switching said valve function to a second position enabling incoming gas from said inlet arrangement to pass via said common inlet conduit through said first conduit containing said first heat exchanger with heat absorber thereby becoming heated before passing through and leaving said decomposition chamber through a second conduit containing a second heat exchanger with heat absorber, whereafter the now cooled gas is transported in said common outlet conduit further downstream into said outlet arrangement,
iii) switching said valve function back to said first position.

30. An apparatus for the decomposition of nitrous oxide which is present in exhaled air which is diluted with normal air and derived from one or more patients inhaling a gas containing nitrous oxide, said apparatus comprising a gas flow line along which is located in downstream order
a) an inlet arrangement which in the upstream direction is capable of being placed in simultaneous gas flow communication with said one or more patients,
b) a decomposition unit in which there is
i) a flow-through decomposition chamber in which nitrous oxide is decomposed, and
ii) a heating arrangement comprising a regenerative heat exchanger, and
c) an outlet arrangement.

31. The apparatus of claim 30, wherein said regenerative heat exchanger is configured to first transfer and store heat in the hot gas exiting the decomposition chamber in a heat absorber from which heat subsequently is transferred to incoming gas that is about to enter said decomposition chamber.

32. The apparatus of to claim 30, wherein said regenerative heat exchanger comprises
a) at least two separate heat exchangers each of which contains a heat absorber,
b) at least a multi way valve function permitting reversal of flow through said decomposition chamber, and
c) conduits linked together enabling operation cycles of said regenerative heat exchanger in the form of:
i) switching said valve function to a first position so that hot gas will leave said decomposition chamber through a first transport conduit containing a first heat exchanger with heat absorber, whereafter the obtained cooled gas is transported in a common outlet conduit further downstream into said outlet arrangement,
ii) switching said valve function to a second position enabling incoming gas from said inlet arrangement to pass via said common inlet conduit through said first conduit containing said first heat exchanger with heat absorber thereby becoming heated before passing through and leaving said decomposition chamber through a second conduit containing a second heat exchanger with heat absorber, whereafter the now cooled gas is transported in said common outlet conduit further downstream into said outlet arrangement,
iii) switching said valve function back to said first position.

33. An apparatus suitable for the decomposition of nitrous oxide which is present in exhaled air from one or more patients inhaling a gas containing nitrous oxide, said apparatus comprising a gas flow line along which is located in downstream order
a) an inlet arrangement which in the upstream direction is capable of being placed in simultaneous gas flow communication with said one or more patients,
b) a decomposition unit in which there is a flow-through decomposition chamber containing a catalyst for decomposing nitrous oxide to N₂ and O₂ and in which nitrous oxide is decomposed, wherein said catalyst is selected amongst catalysts which are capable of degrading volatile organic compounds (VOC), and
c) an outlet arrangement.

34. A method for the decomposition of nitrous oxide present in gas derived from air exhaled which is diluted with normal air and is derived from one or more patients inhaling a gas containing nitrous oxide, which method comprises the steps of:
i) connecting at least one of said patients to an apparatus comprising a gas flow line along which is located in downstream order
a) an inlet arrangement which in the upstream direction is capable of being placed in simultaneous gas flow communication with said one or more patients,
b) a decomposition unit in which there is a flow-through decomposition chamber in which nitrous oxide is to be decomposed,
c) an outlet arrangement, and
d) a gas regulating arrangement comprising a gradually adjustable blower for adjusting the flow of gas entering said decomposition chamber,
ii) flowing said gas from said at least one patients through said inlet arrangement and through said decomposition unit at conditions, including heating to the process temperature, enabling decomposition of nitrous oxide in said decomposition chamber, and
iii) changing the number of patients connected to said apparatus at least once and adjusting said flow through said decomposition unit using said blower to a higher value if said number is increased and to a lower value if said number is decreased.
